(19) United States
(12) Patent Application Publication
(10) Pub. No.: US 2024/0075396 A1
(43) Pub. Date: Mar. 7, 2024

(54) POWER DRIVE SUPER CAPACITOR, INDUCTIVE POWER SOURCE AND SYSTEM FOR TRACK-BASED VEHICLE SYSTEMS

(71) Applicant: DIGITAL DREAM LABS, LLC, Pittsburgh, PA (US)

(72) Inventor: Thomas Schubert, Catawba, SC (US)

(73) Assignee: DIGITAL DREAM LABS, LLC, Pittsburgh, PA (US)

(21) Appl. No.: 17/640,061

(22) PCT Filed: Sep. 1, 2021
(86) PCT No.: PCT/US2021/048678

§ 371 Date: Mar. 3, 2022

(51) Int. Cl. A63H 18/12; B60L 50/40; B60L 53/12; H02J 7/00; H02J 50/12

(52) U.S. Cl. CPC A63H 18/12; B60L 50/40; B60L 53/12; H02J 7/00034; H02J 50/12; B60L 2200/20

(57) ABSTRACT

The present invention comprises a power source using super capacitors as a battery replacement in a vehicle racing kits.

### CROSS-REFERENCE TO RELATED APPLICATION

This application is a PCT International Application claiming priority to U.S. Provisional Application Ser. No. 63/073,079, filed on Sep. 1, 2020, which is incorporated by reference herein in its entirety.

### BACKGROUND OF THE INVENTION

### Field of the Invention

This invention relates to toy racing or track-based vehicles, sets and systems and, more particularly, this invention relates to powering such vehicles, sets and systems.

### Description of Related Art

Historically, toy racing systems include toy vehicles and interconnected tracks upon which the vehicles run. The vehicles are powered through a variety of means including but not limited to being spring-powered and/or battery powered and/or having electric motors. In some systems, the vehicles receive an electric current from conducting strips in the track. In other systems, the vehicles must be charged prior to placing them on the track.

Systems that require charging prior to being used can be frustrating for children (and adults) because these systems require the users to anticipate when they will want to use the racing systems, charge the vehicles for up to several hours prior to use and then play with the vehicles and systems. For some children, this degree of anticipation and planning makes the toys frustrating and undesirable. One example of a popular racetrack system currently on the market that requires that the vehicles be charged prior to use is the Anki Overdrive® system. Anki Overdrive® vehicles will run for approximately 12 minutes after a full 10-minute charge. Anki Overdrive® vehicles must be charged using the supplied charging platform and adapter. The requirement of pre-charging the vehicles, when combined with the relatively short running time (which can be shortened by use at higher speeds) presents frustratingly limited play situations for users. Pre-charging and short run-times are not problems exclusive to the Anki Overdrive® system but exist with many racing systems and vehicles on the market today. The present invention addresses these problems and needs by presenting a power drive capacitor, inductive power source and related system that charges the vehicles while they are driving on the track(s).

### BRIEF SUMMARY OF THE INVENTION

The following technical abstract details a power source using super capacitors as a battery replacement or charger in vehicle racing kits, including without limitation, the Anki Overdrive® car racing kit.

The super capacitor referred to herein as the vehicle power assembly replaces or supplements a current battery, such as, without limitation, an NiMh battery, used to drive the motors and electronics of the cars in the Anki Overdrive® system and other similarly powered toy racing systems and/or track-based vehicle systems.

In one embodiment, the power source and system of the present invention is designed to add to the current Anki Overdrive® starter kit (or any similar racing kits) without any re-design of the off-the-shelf technology. In this embodiment, a printed circuit board (“PCB”) that matches the dimensions of the current battery, allows for easy manufacturing by replacing the battery with the vehicle power assembly board of the present invention.

The system and method of the present invention includes: (1) at least one track clip connected to a track segment of the track and operable to sense the entry to and departure of the vehicle from the track clip; (2) a power supply assembly housed within the track clip and configures to generate energy in a non-contact electromagnetic field through direction of an electrical current to an inductive coil when the vehicle is on the track clip; and (3) a vehicle power assembly located in the vehicle and configured to convert and store the electromagnetic field energy in a capacity for powering the vehicle. The system and method of the present invention operates such that the capacitor in the vehicle power assembly is recharged when the vehicle drives over a track clip.

As described more fully herein, these components can be used as described or with minor modifications with a wide variety of currently available vehicle racing systems and components.

### BRIEF DESCRIPTION OF THE SEVERAL VIEWS OF THE DRAWINGS

For the purpose of facilitating understanding of the invention, the accompanying drawings and descriptions illustrate preferred embodiments thereof, from which the invention, various embodiments of its structures, construction and method of operation and many advantages may be understood and appreciated. The accompanying drawings are hereby incorporated by reference.

FIG. 1A illustrates a portion of a vehicle racing track and, in particular, a cross-sectional side view of a track and one embodiment of the track clip of the present invention in the racing track;

FIG. 1B is a top view of a vehicle racing track according to the present invention;

FIG. 2 is a block diagram of one embodiment of a power supply assembly according to the present invention;

FIG. 3A shows a vehicle with a vehicle power assembly replacing a battery in a traditional toy racing vehicle;

FIG. 3B shows a vehicle power assembly according to one embodiment of the present invention; and

FIG. 4 shows a flowchart of the process steps for generating a desired energy to transmit from the power supply assembly according to one embodiment of the present invention.

### DETAILED DESCRIPTION OF THE INVENTION

The following describes example embodiments in which the present invention may be practiced. This invention, however, may be embodied in many different ways and the description provided herein should not be construed as limiting in any way. Among other things, the following invention may be embodied as systems, methods, or devices. The following detailed descriptions should not be taken in a limiting sense. The accompanying drawings are hereby incorporated by reference.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present invention is a power drive capacitor, inductive power source and related system that charge track-based vehicles while they are driving on the track(s). The present invention works with toy racing vehicles and systems in which the cars are powered by rechargeable lithium batteries (or lithium polymer batteries). The present invention's advantages are most applicable when it is incorporated into racing vehicles and systems that would have otherwise been required to be charged prior to use (usually on a separate charging station). While the present invention can be combined with existing racing vehicles and systems, it also can be incorporated into and sold as a component of new vehicles and racing systems, robots or any other type of toy that uses a base track. For the purposes of this invention, the track can have any shape, size, or form.

A non-limiting example would be a race car and track system. Historically, the race car would need to be charged prior to racing it on the track. However, the present invention enables the immediate use of an uncharged car. More specifically, a user can place the car on the track, which has a track clip and associated power supply assembly connected to the track. After a short period of time (approximately 60 seconds for this example) an indicator (such as a green light) on the car and on the track clip will glow green or other preset color. The car now can be driven around the track for unlimited racing times. Every time the car goes over the track clip and associated power supply assembly connected to the track, the super capacitor in the vehicle power assembly charges. If the user decides to take a break from racing, the car is in hibernation mode, meaning it is drawing very little current. The user can continue racing after an hour or two or even eight, etc. as the majority of charge is still in the super capacitor.

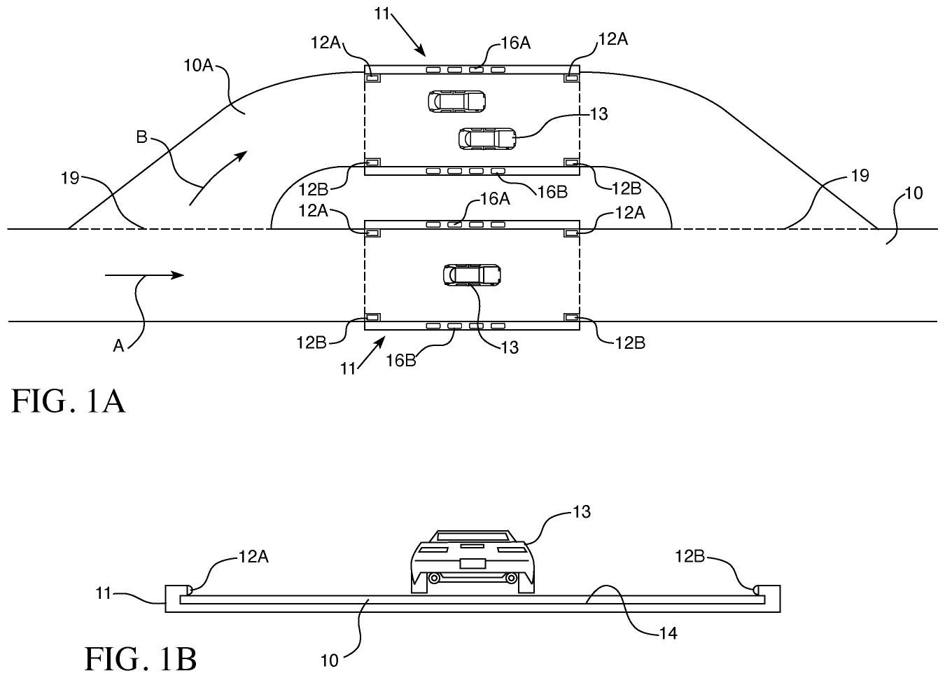

As shown in FIGS. 1A and 1B, track clip 11 attaches underneath any straight track piece 10 (or similar track piece of an off-the-shelf system). In one embodiment, clip 11 snaps onto track piece 10, but other forms of attachments also can be utilized. Embedded on each side of the clip 11 are at least one sets of proximity sensors 12A and 12B. In one embodiment, sensors 11 are infrared sensors; however, forms and types of sensors can be used that act to detect the movement of vehicle or car 13. In particular, and with reference to 1A, sensors 12A and 12B on the left side track 10 or 10A determine when a vehicle 13 enters the clip 11 and aid in calculating the speed or velocity and acceleration of the vehicle 13. In FIG. 1A, vehicle 13 is moving left to right in direction of arrow A, and the first set of sensors of 12A and 12B operate to detect a vehicle 13 and also the speed of the vehicle 13 as described below. Multiple sets of sensors 12A and 12B can be used to detect the acceleration or deceleration of a vehicle 13. Clip 11 also has indicator lights 16A and 16B that either light up and/or generate a specific color, such as green, when a vehicle 13 is being charged as the vehicle 13 drives over power supply assembly 20 in track clip 11. The track clip 11 of this invention can be designed to be a variety of dimensions such that it fits under track pieces 10 of different shapes, sizes, and brands.

Alternatively, the track clip 11 of the present invention can be designed and incorporated into any similar track-based vehicle system. For example, clips 11 can be embedded directly into the straight tracks of a racecourse. In another embodiment, an optional track assembly can be used as shown in FIG. 1B. This optional track assembly provides a secondary “pit stop” lane 10A which is shown by arrow B. A track clip 11 can be located in this alternative lane 10A, which allows for merging on and off the main track 10 for pit stops or other racing applications. Dotted lines 19 in FIG. 1B show the configuration of a straight track 10 (with removal of the alternative pit stop lane 10A shown above the straight track 10).

Only one clip 11 is required for a standard starter kit of the present invention, which has a fixed length and allows four cars 13 to be used. For larger track arrangements, more clips 11 can be added to ensure the charging of all cars 13 over large areas of tracks 10. In order to assess and identify the number of additional clips 11 needed, a test track run can be run that moves the cars 13 around the track at a preset speed, so the required energy can be calculated, and, if needed, more clips 11 can be added. Also, the system can provide a chart that lists a number of clips 11 advisable for a particular length of track 10.

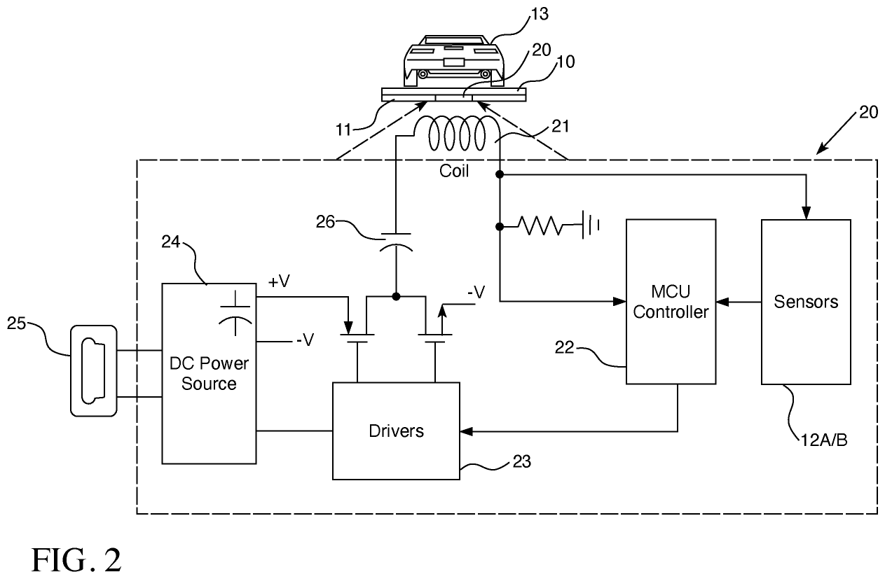

Referring to FIG. 2, a power supply assembly 20 is embedded within the flat surface (or flat portion) 14 of the track clip 11 and under the width of the track 10. Power supply assembly 20 includes an inductive coil 21, a microcontroller unit or MCU 22, one or more high current drivers 23, and a direct current or DC power source 24. In operation, power source 24 supplies voltage to power supply assembly 20. In one embodiment, as shown in FIG. 2, a USB adaptor 25 is used to provide current. USB adaptor 25 also can be used, in an alternative embodiment, to provide external communications from a user to MCU 22 and provide output from MCU 22 to a user. The current provided by USB adaptor 25 is at least 5 volts. This voltage can be increased to provide more speed and distance capability to the vehicle 13. Other more traditional energy sources and adapters can be used, such as traditional wires and plugs that connect to wall outlets or to various external batteries, with similar voltage ranges. If a wall outlet is used to provide current and power, a converter is needed to convert AC to DC current.

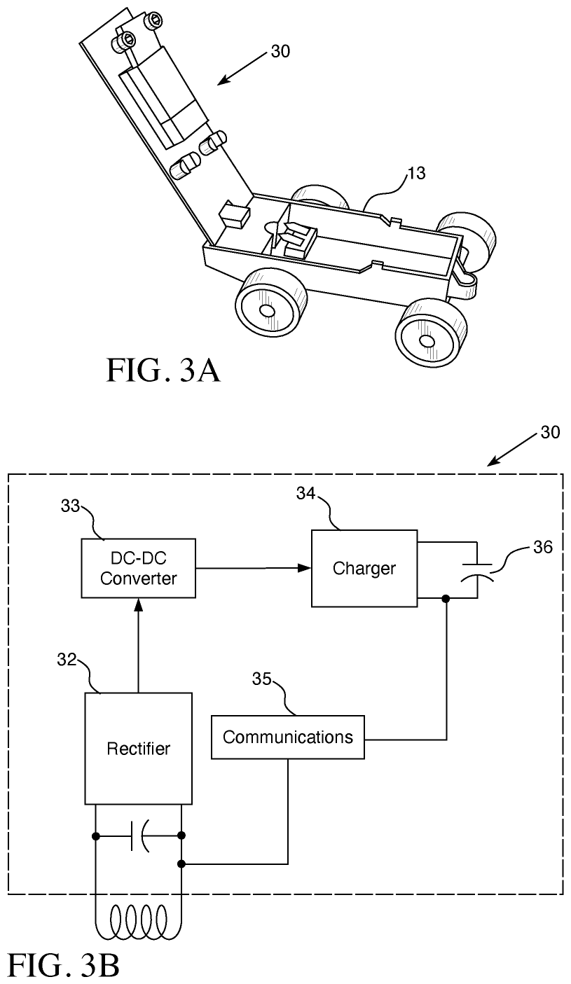

Current is directed to inductive coil 21 in order to energize the coils and transmit a non-contact electromagnet induction field that couples through track 10 or 10A with a receiving inductive coil 31 in vehicle power component 30 (shown in FIG. 3). The amount of voltage directed to coil 21 is controlled by one or more high current drivers 23, which oscillate the coils in coil 21, as directed by MCU 22 in order to generate a desired resonance frequency for the generated non-contract electromagnet induction field. Coil 21 is a TX coil in one embodiment, but other known types of coils capable of use for induction can be used. Drivers 23 and MCU 22 are standard components capable for use in the described system of the invention. To ensure enough energy is delivered through the coil 21, a capacitor 26 also is used, in association with MCU 22, to ensure enough current can be sourced to energize coil 21.

Because of the high currents involved, continuous charging of the coil 21 is not possible. For this reason, sensors 12A and 12B are used to detect a car 13 entering the power drive clip 11, as described above. Sensors 12A and 12B are connected to MCU 22, whereby the speed of the car 13 is calculated by MCU controller 22, and MCU 22, in turn, directs the required pulse or field “on time” of the non-contact electromagnetic field being generated while vehicle 13 is traveling on top of power supply assembly 20. This process determines how much energy is transmitted to the car clip 13 to ensure a full charge to car 13. More specifically, the speed or velocity of vehicle 13 is determined by measuring the time difference between the passage of the front and back wheels of vehicle 13, as detected by sensors 12A and 12B. The distance between the front and back wheels is preset and fixed, and this time difference is transmitted to MCU 22 for determination of speed. The distance between the original set of sensors 12A and 12B also is preset, and based on the determined speed of vehicle 13, MCU 22 also determines when vehicle 13 travels to and how long vehicle 13 is over power supply assembly 20.

MCU 22 also determines how much power is to be conveyed by coil 21 and for how long. Coil 21 cannot be powered for extended periods of time because heat is generated in the process. For example, 25 watts of power could be generated, which would generate considerable heat. Therefore, the “on time” for power generation needs to be limited to when vehicle 13 can receive the power. In a further embodiment, therefore, MCU 22 also can detect if any foreign ferrous material comes in contact with the coil 21. This detection occurs through the known process of using burst detection by emitting a periodic short pulse from coil 21 at low energy. This pulse can occur every second, for example. This same process is used in standard metal detectors. MCU 22 operates to monitor and sample the waveform generated by coil 21, and this waveform will distort if a foreign ferrous material is on the track 10 or 10A.

At the same time, the power needs to be sufficient to power vehicle 13 at desire speed over a preset length of track until recharged again through the same process. MCU 22 makes this determination based on, among other factors: (1) speed of vehicle 13, (2) length of track 10, (3) the amount of voltage conveyed to coil 21, (4) the number of coils in coil 21, (5) desired top speed of vehicle 13, and (6) the number of desired laps until recharging. Based on desired performance as to speed and distance, coil 21 power can be varied from about 5 watts to 25 watts through MCU 22.

This field “on time” can be varied, depending upon the calculations by the MCU 225, to simulate actual fuel efficiency for racing. Like in Formula 1 racing cars, it is also possible to slow the car 13 down while traveling in pit lane 10A. This is similar to NASCAR where fuel is limited to the way a car is driven. The speed of car 13 typically is controlled by user through a smart phone or smart tablet application, which communicates with car 13 through separate components not addressed by the present invention.

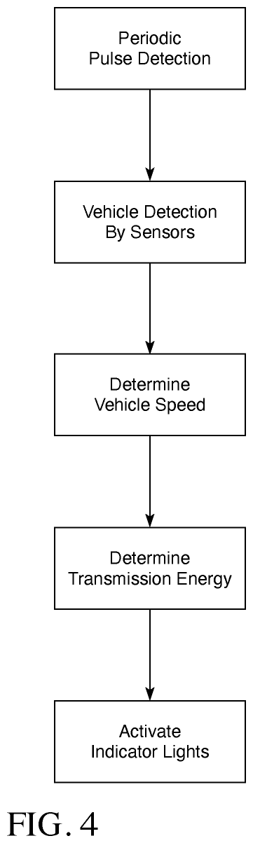

In operation, and as shown in FIG. 4, MCU 22 controls the following method steps: (step 41) periodic emission (e.g., every second) of a short (e.g., one millisecond pulses) to check for objects within the range of power supply assembly 20, (step 42) receipt of transmissions from sensors 12A and 12B when a vehicle 13 is detected, (step 43) determination of vehicle speed, (step 44) determination of desired energy to transmit from coil 21, and (step 45) activation of indicator lights 16A and 16B (which are connected to MCU 22) when vehicle 13 is over or on top of power supply assembly 21 and/or charging is occurring. This last step is optional, but the indicator lights also can perform other functions. For example, indicator lights 16A and 16B also can be controlled to signal the start of a race (red to green, for example) or the end of a race. This is very similar to start racing lights at racing venues, adding another layer of real excitement when racing against an application or other drivers. Also, in connection with step 43, MCU 22 can determine, if needed depending upon the distance between sensors 12A and 12B and coil 21, the time when vehicle 13 is positioned over coil 21. This determination is based on the velocity of vehicle 13 and the known distance between sensors 12A and 12B and coil 21. This determination of time precludes an early or late activation of the power conveyance from coil 21 and any related unnecessary generation of heat.

Referring to FIGS. 3A and 3B, vehicle power assembly 30 can be clipped onto or inserted into vehicle 13 as a substitute power supply for a battery. Power assembly 30 includes inductive receiver coil 31, rectifier 32, DC-DC converter 33, charger 34, communications module 35, and super capacitor 36. In operation, as a car 13 passes over the clip 11 on a standard track 10 or in pit lane 10A, the non-contact electromagnetic field generated by inductive coil 21 is coupled to the receiver coil 31. Receiver coil is preferably an RX coil, but other coil forms can be used. The receiver coil 31 is located near the bottom of vehicle 13 either through a clip that attaches to vehicle 13 or an internal insert. If vehicle power assembly 30 is clipped to vehicle 13, receiver coil 31 is located on the PCB underneath the chassis of vehicle 13. If assembly 30 is located in vehicle 13, receiver coil 31 is similarly located at the bottom of assembly 30. In either of these embodiments, an air gap of at least 1 to 2 mm. A current is then generated within the receiver coil 31, which is next rectified by rectifier 32, filtered and directed to charge super capacitor 36. More specifically, rectifier 32 converts AC current to DC current. DC-DC converter 33 regulates the voltage of the current. Charger 34 conveys power to vehicle 13. This power can be provided in alternative ways, including the charging of a standard battery, activating a dead battery, or otherwise substituting for a battery. Communications module generates wireless communication to a user, such as by Bluetooth, as to the operating parameters, including voltage, of vehicle power assembly 30. The capacitance value of super capacitor 36 will depend upon how long the charge in the capacitor needs to last. These values will range from about 0.2 F (Farad) to 4.7 F in most embodiments in capacitor 36. This value also may be limited by the size of vehicle 13 and the internal space available for component 30.

Because of the large capacitance of the capacitor 36, the energy stored dissipates over time, energizing the motors which move the cars 13 along the track. Every time a car 13 enters a track clip 11, the car 13 will charge super capacitor 36, giving enough energy to complete the next rotation of the track layout. This allows the cars 13 on the track infinite running time. Depending on how the car 13 is driven, this charge can last from about 60 seconds to minutes or hours.

When a car 13 is placed on the track, the capacitor 36 often is discharged and has no energy. For this reason, before starting any race where the cars 13 have been off the tracts for at least an hour, placing the cars 13 on the clip 11 allows for the capacitors 36 to charge.

As explained above, the power drive clips and system of the present invention can be combined with a variety of off-the-shelf racing systems or incorporated into a system prior to sale. Any number of the power drive clips and system can be used with a racetrack depending upon the length of the track, the power needs of the vehicles and the number of vehicles being used. The power drive clips and system can be integral to the main racing track or incorporated into a sidetrack or pit lane. Additionally, while the present invention has been described in the contact of racing tracks, it will be obvious to one skilled in the art that it can be incorporated into other track-based toys and devices that use a similar battery structure for power, such as model trains, robots, drones, essentially anything that requires a power source.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover all modifications and variations of this disclosure provided they come within the scope of the appended claims and their equivalents. Among other things, the following invention may be embodied as methods or devices. The detailed descriptions of the various embodiments of the present invention should not be taken in a limiting sense.

What is claimed is:

1. A rechargeable power system for a vehicle configured to operate on a fixed track, the system comprising:
at least one track clip connected to a track segment of the track and operable to sense the entry to and departure of the vehicle from the track clip;
a power supply assembly housed within the track clip and configures to generate energy in a non-contact electromagnetic field through direction of an electrical current to an inductive coil when the vehicle is on the track clip; and
a vehicle power assembly located in the vehicle and configured to convert and store the electromagnetic field energy in a capacity for powering the vehicle;
whereby the capacitor in the vehicle power assembly is recharged when the vehicle drives over a track clip.

2. The power system of claim 1, wherein the track clip has a flat upper surface that is at least as wide as a bottom surface of the track segment to which the track clip is connected, and the track clip is connected whereby the upper surface of the track clip rests against the bottom surface of the track segment.

3. The power system of claim 1, where in track clip is located within the track segment.

4. The power system of claim 1, where the track clip has two opposing sides that extend above the track segment and contain at least one set of sensors which determine when the vehicle enters and leaves the track clip.

5. The power system of claim 4, wherein the power supply assembly comprises an inductive coil, a microcontroller unit or MCU, one or more high current drivers, and a direct current power source.

6. The power system of claim 5, wherein the power supply assembly further comprises a capacitor.

7. The power system of claim 4, wherein signals from the sensors as to the entry and departure of the vehicle from the track clip are sent to the microcontroller unit and the microcontroller unit is thereby able to determine the speed and acceleration of the vehicle.

8. The power system of claim 5, wherein amount of voltage in the electrical current directed to the inductive coil is controlled by the one or more high current drivers and the microcontroller unit to generate a desired resonance frequency for the generated electromagnet field.

9. The power system of claim 1, wherein the vehicle power assembly comprises receiver inductive coil, rectifier, DC-DC converter, charger, communications module, and super capacitor.

10. The power system of claim 9, wherein the capacitance value of the capacitor can vary depending upon how long the charge in the capacitor is needed for vehicle operation and the capacitance value ranges from about 0.2 to 4.7 Farads.

11. A method of recharging the power supply of a vehicle on a fixed track, the method comprising:
connecting at least one track clip to a track segment of the track, the track clip operable to sense the entry to and departure of the vehicle from the track clip;
housing a power supply assembly within the track clip, the power supply assembly configured to generate energy in a non-contact electromagnetic field through direction of an electrical current to an inductive coil when the vehicle is on the track clip; and
locating a vehicle power assembly in the vehicle, the vehicle power assembly configured to convert and store the electromagnetic field energy in a capacity for powering the vehicle;
whereby the capacitor in the vehicle power assembly is recharged when the vehicle drives over a track clip.

12. The method of claim 11, wherein the track clip has a flat upper surface that is at least as wide as a bottom surface of the track segment to which the track clip is connected, and the track clip is connected whereby the upper surface of the track clip rests against the bottom surface of the track segment.

13. The method of claim 1, where in track clip is located within the track segment.

14. The method of claim 1, where the track clip has two opposing sides that extend above the track segment and contain at least one set of sensors which determine when the vehicle enters and leaves the track clip.

15. The method of claim 4, wherein the power supply assembly comprises an inductive coil, a microcontroller unit or MCU, one or more high current drivers, and a direct current power source.

16. The method of claim 15, wherein the power supply assembly further comprises a capacitor.

17. The method of claim 14, wherein signals from the sensors as to the entry and departure of the vehicle from the track clip are sent to the microcontroller unit and the microcontroller unit is thereby able to determine the speed and acceleration of the vehicle.

18. The method of claim 15, wherein amount of voltage in the electrical current directed to the inductive coil is controlled by the one or more high current drivers and the microcontroller unit to generate a desired resonance frequency for the generated electromagnet field.

19. The method of claim 11, wherein the vehicle power assembly comprises receiver inductive coil, rectifier, DC-DC converter, charger, communications module, and super capacitor.

20. The method of claim 19, wherein the capacitance value of the capacitor can vary depending upon how long the charge in the capacitor is needed for vehicle operation and the capacitance value ranges from about 0.2 to 4.7 Farads.
